(19) United States
(12) Patent Application Publication
(10) Pub. No.: US 2002/0155823 A1
(43) Pub. Date: Oct. 24, 2002

(54) Method and apparatus for monitoring packet based communications in a mobile environment

(75) Inventors: Dan Alan Preston, Bainbridge Island, WA (US); Robert Pierce Lutter, Tacoma, WA (US)

Correspondence Address: MARGER JOHNSON & MCCOLLOM PC, 1030 SW MORRISON STREET, PORTLAND, OR, 97205, US

(73) Assignee: Medius, Inc., Seattle, WA (US)

(21) Appl. No.: 09/841,755

(22) Filed: Apr. 24, 2001

(51) Int. Cl. H04M 11/00

(52) U.S. Cl. 455/406; 455/407; 455/405

(57) ABSTRACT

A mobile unit establishes a session for transferring content with a service. The mobile unit then identifies a cost of service rate for the content. The mobile unit derives cost of service data according to the type of content and the identified cost of service rate. The cost of service data derived by the mobile unit is then sent back to the service provider.

### BACKGROUND

Mobile endpoints such as cars, pedestrians, etc. often need to communicate with networks and other packet based telecommunications systems. This is currently performed over wireless communications links that are established between some transmitting point in the network and a mobile unit such as cellular telephones. Because the mobile user may be communicating between different wireless network devices during the same session, it is difficult to accurately track how many packets are transmitted back and fourth from the mobile unit during the wireless session.

For example, for one period of the communication session, the mobile unit may receive and transmit packets with a first network processing device through a first high bandwidth satellite communication link. During that same session, the mobile unit may move into a different geographic region where a second network processing device with a lower bandwidth wireless communication link is tasked with maintaining the same session. Internet routers and switches do not have the ability or processing capacity to dynamically monitor and manage mobile communication sessions.

It may be desirable for a content provider to broadcast packets over a wireless communication channel. There is currently no way to accurately track what mobile units have received the broadcast packets or how much of the broadcast is used by different mobile units.

The present invention addresses this and other problems associated with the prior art.

### SUMMARY OF THE INVENTION

A mobile unit establishes a session for transferring content with a service. The mobile unit then identifies a cost of service rate for the content. The mobile unit derives cost of service data according to the type of content and the identified cost of service rate. The cost of service data derived by the mobile unit is then sent back to the service provider

### BRIEF DESCRIPTION OF THE DRAWINGS

FIG. 1 is a diagram of a content monitoring system.

FIG. 2 is a diagram of an Open System Interconnection (OSI) model that shows the content monitoring in FIG. 1 being performed at the session layer or higher.

FIG. 3 is a flow diagram showing how a mobile unit provides content monitoring.

FIG. 4 is a flow diagram showing how Cost of Service (COS) data is generated.

FIG. 5 is a flow diagram showing how different COS parameters are used to generate the COS data.

FIG. 6 is a flow diagram showing how different service content is identified and used to generate the COS data.

FIG. 7 is a flow diagram showing how the COS data is encrypted before being transmitted back to a network.

FIG. 8 is a flow diagram showing how a Virtual Central Office (VCO) processes the COS data.

FIG. 9 is a schematic diagram of the mobile unit.

FIG. 10 is a detailed diagram of the mobile unit shown in FIG. 9.

### DETAILED DESCRIPTION

The description of the content adapted control system below uses the example of content adapted Cost Of Service billing. However, it should be understood that the same scheme can be used for any type of content adapted monitoring and control. For example, the detection of content can be used as a parameter for determining how data is processed during a communication session, how the data is routed in the network, or can determine what data has priority in the session.

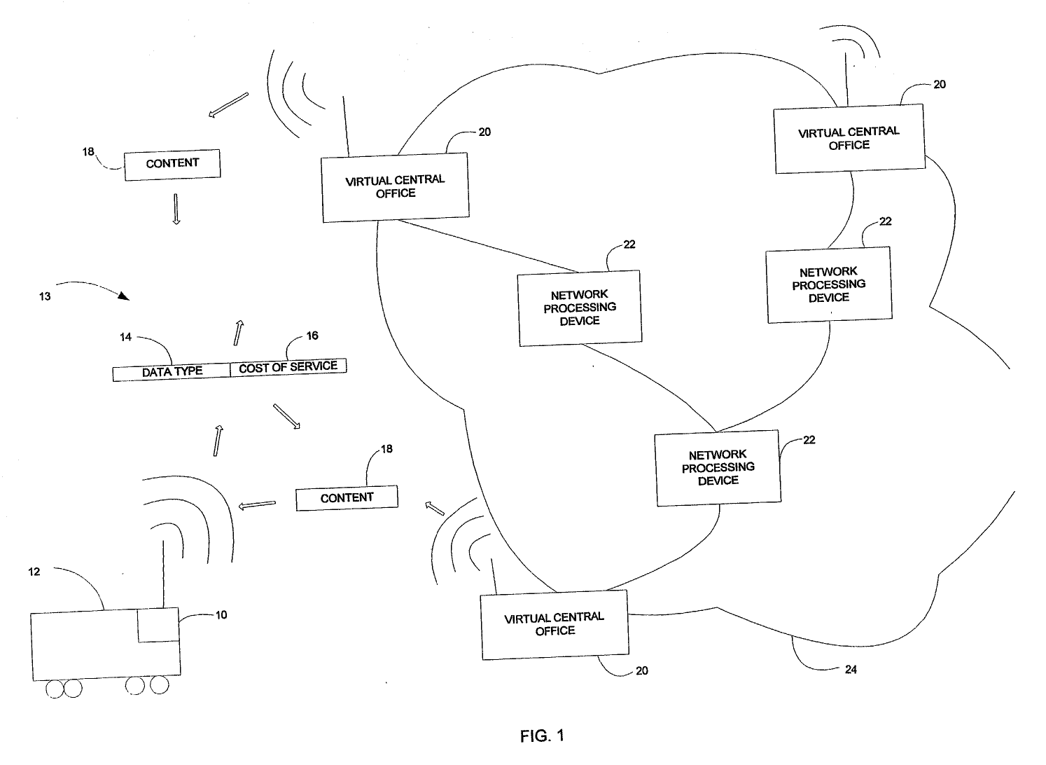

FIG. 1 shows a network 24 that includes multiple network processing devices 20 and 22. The network processing devices in one example include routing or switching equipment for packet transferring packets using protocols such as the Internet Protocol (IP). Some of the network processing devices 20 also operate as Virtual Central Offices (VCOs) that conduct or receive data transferred over wireless communication channels. A mobile unit 10 in one example is located in a car 12 and communicates with the VCOs 20.

The wireless communication channel established between the VCOs 20 and the mobile unit 10 can be any existing radio wave, microwave, cellular, etc. system available for transferring content 18. The content 18 can include voice or digital data and in one example is transmitted in packets or frames. A communication session is established between the mobile unit 10 and one or more of the VCOs 20. The mobile unit 10 monitors the amount and possibly the type of content 18 that is transferred with the VCOs 20 during the session. After the session is completed, the mobile unit 10 sends one or more COS packets 13 back to any one of the VCOs 20. The COS packet 13 includes a data type field 14 and a Cost Of Service (COS) data 16. The data type field 14 is used by the VCO 20 to identify the correct address for routing the COS data 16. The COS data 16 identifies one or more communication sessions, services provided during that communication session, and the costs for providing those services.

The mobile unit 10 dynamically tracks the content 18 exchanged with network 24 during the communication session. This allows the cost of the individual services provided during the communication session to be more efficiently and accurately tracked and accounted. For example, the mobile unit 10 may move to a different geographic region while conducting a communication session. It may be necessary at that time to start communicating through a different VCO 20. It is not necessary for different VCO's 20 that participate in the same session with mobile unit 10 to exchange or even track their portions of the billing information. That is because the mobile unit 10 monitors all the cost related to the services used during the session.

Because the mobile unit 10 tracks the type and amount of content 10 used, an accurate accounting can be determined for data broadcast by any of the VCOs 20. Thus, the monitoring system in the mobile unit 10 has the capacity of generating billing data only for the services that were actually used. For example, the VCOs 20 may constantly broadcast GPS data. The GPS service may currently bill each customer a particular fee per month. This is an unfair billing scheme for users who only rarely use the GPS service. The mobile unit 10 can track COS data only for the GPS information actually requested or received by the mobile unit 10. This provides the ability to accurately bill only for those services actually used.

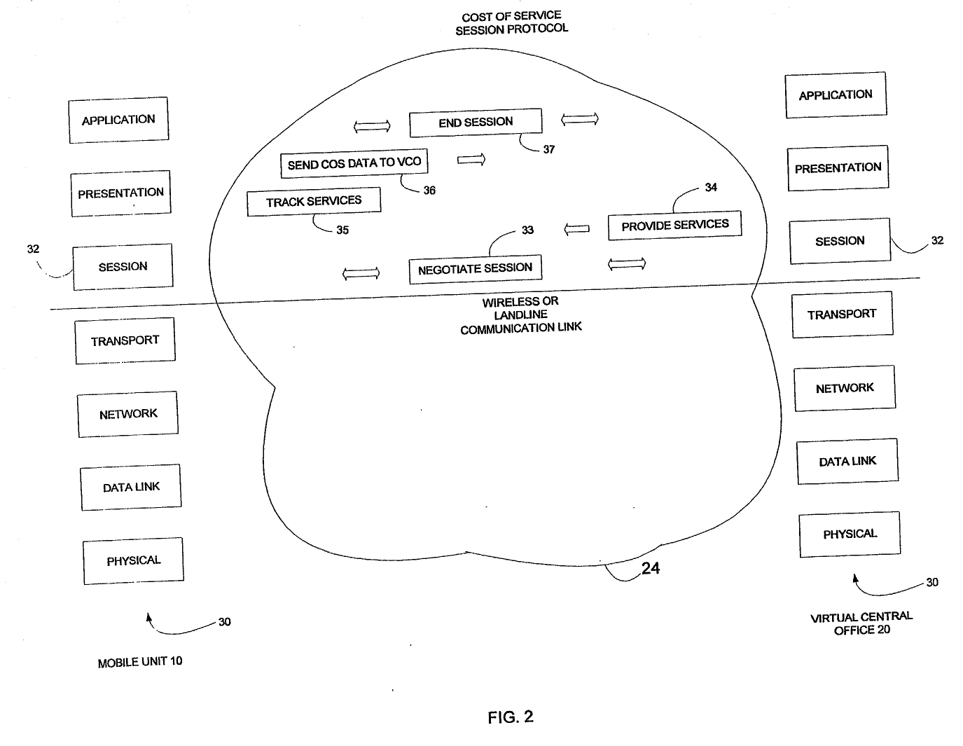

FIG. 2 shows the different layers 30 of the Open System Interconnection (OSI) model. The mobile unit 10 conducts Cost of Service (COS) processing at the session layer or higher of the OSI model. Because COS processing is conducted at the session layer or higher, COS processing can be adapted to the particular session currently being conducted at the mobile unit. This also means that COS processing can be conducted independently of the transport or data link session used to transfer packets between a Virtual Central Office and the mobile unit. The COS session protocol can be implemented using any existing software such as C++ or Java.

The session is established in block 33. The session for the purposes of COS monitoring may identify a particular type of content that is transferred during the session, a service that is going to be provided during the session, and/or a COS rate associated with the content that is transferred during the session. The VCO 20 then provides one or more services 34 to the mobile unit in block 34. The mobile unit dynamically tracks the services provide during the session in block 35. After the session is completed, the mobile unit sends the COS to the VCO in block 36. The session is then terminated in block 37

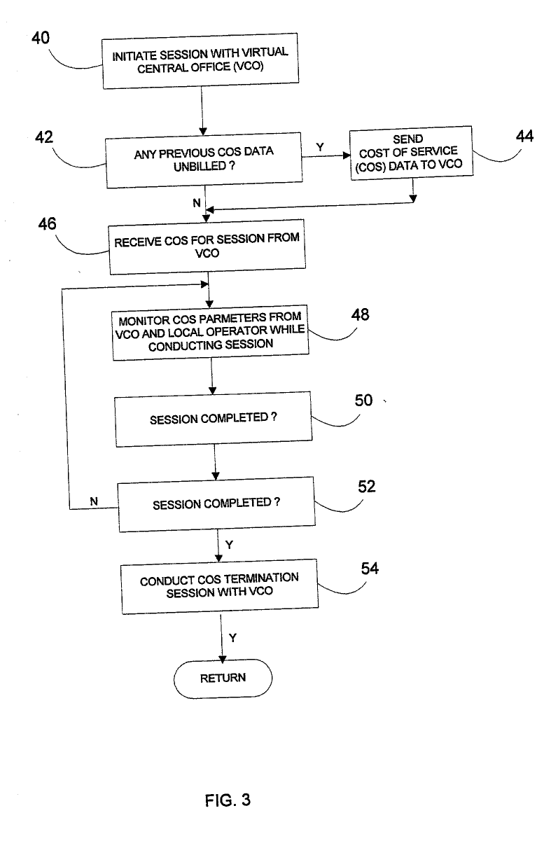

FIG. 3 shows how the mobile unit conducts a Cost of Service Protocol (COSP) with the VCOs 20. A session is initiated either by the mobile unit 10 or one of the VCO's 20 in block 40. A session is any communication between any VCO 20 and the mobile unit 10 that needs to be billed to the operator of mobile unit 10. While the session is typically conducted over a wireless communication channel between the VCOs 20 and a mobile unit 10, this is not necessary. The same monitoring and billing protocol can be used for any computer or endpoint that is either connected to network 24 either by a wireless link or a hardwired link.

In block 42 the mobile unit 42 checks to see if any previous sessions remain unbilled. An unbilled session refers to any COS data that has yet to be successfully transferred to a VCO 20. If any previous sessions are unbilled, the mobile unit 10 sends the COS data for that previous session to the VCO 20 before progressing any further in the current session. In an alternative embodiment, the mobile unit 10 may only download COS data for sessions to the VCO 20 periodically, for example, once every month.

In block 46 the VCO 20 may send the mobile unit 10 a COS rate associated with the content that is to be transferred during the session. The COS rate may be sent in a COS field in packet headers. One of the VCOs 20 may alternatively determine the cost of the session based on the COS data 16 sent back from the mobile unit 10. In this embodiment, the mobile unit 10 only needs to send back the type of content and possibly the amount of the content transferred during the session.

The mobile unit 10 starts monitoring the session with the VCOs 20 in block 48. During the session, the mobile unit 10 monitors for any COS parameters that may change during the session. For example, the user may change the services or content that is being provided in the session from receiving voice call services to receiving email services. The COS rate associated with the voice call services may be different than the COS rate associated with the email services. The mobile unit 10 adjusts the COS rate according to the COS parameters detected from either the VCO 20 or the user of the mobile unit 10.

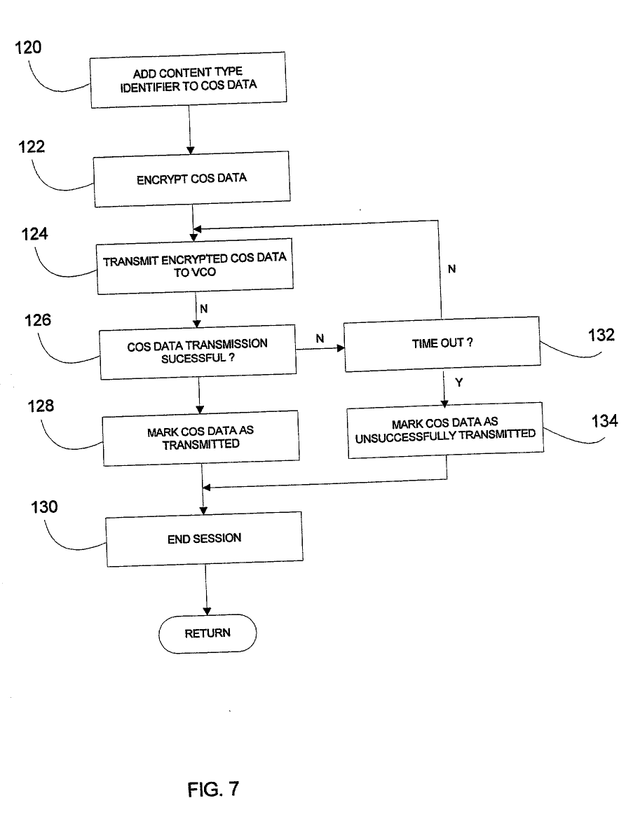

The mobile unit in decision block 52 continues to monitor the COS parameters until the session is completed. The session may be completed either by the user pressing an end key on the mobile unit 10 or successful transmission of the content provided by the service. The mobile unit conducts a COS termination session with the VCO 20 in block 54 that is described in further detail below in FIG. 7.

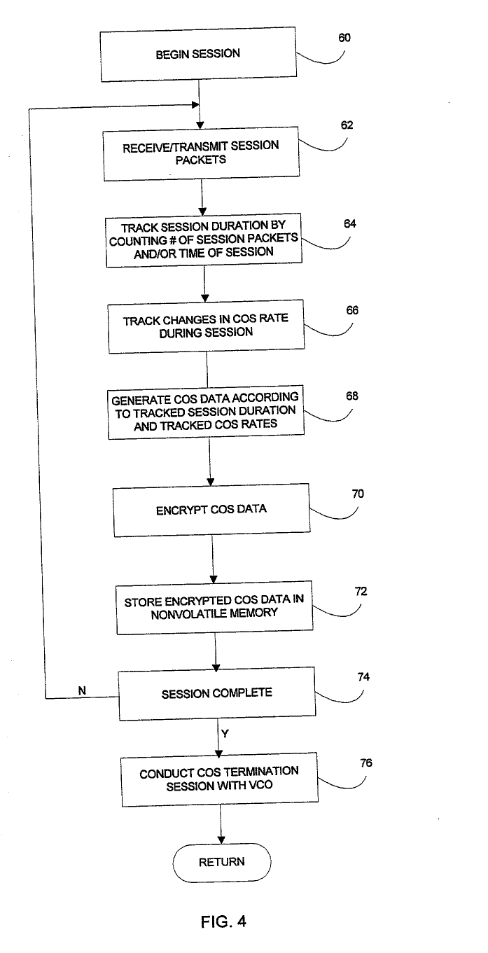

FIG. 4 shows in more detail how the mobile unit 10 generates COS data. The session is initiated in block 60 as previously described in FIGS. 2 and 3. Packets are transferred during the session in block 62. The mobile unit in block 64 tracks the session by counting the number of received packets and/or transmitted packets during the session. The mobile unit may also, or alternatively, track the duration of the session in block 64. The scheme for tracking the session in one embodiment is negotiated between the mobile unit 10 and VCO 20 during session initiation.

In block 66 the mobile unit 10 tracks any session parameters that may cause a change in the COS rate used in the session. For example, a change in the content of the data being transferred in the session, a change in the service currently provided in the session or a change in the quality of the service provided for the session. The COS data is generated in block 68 according to the session duration and COS rates tracked in blocks 64 and 66. For example, a first COS rate may apply to a first portion of the packets or time of the session and a second COS rate may apply to a second portion of the packets or time of the same session. The COS data may include a total cost for the session or break up the cost of the session according to the different rates and types of content that were exchanged during the session.

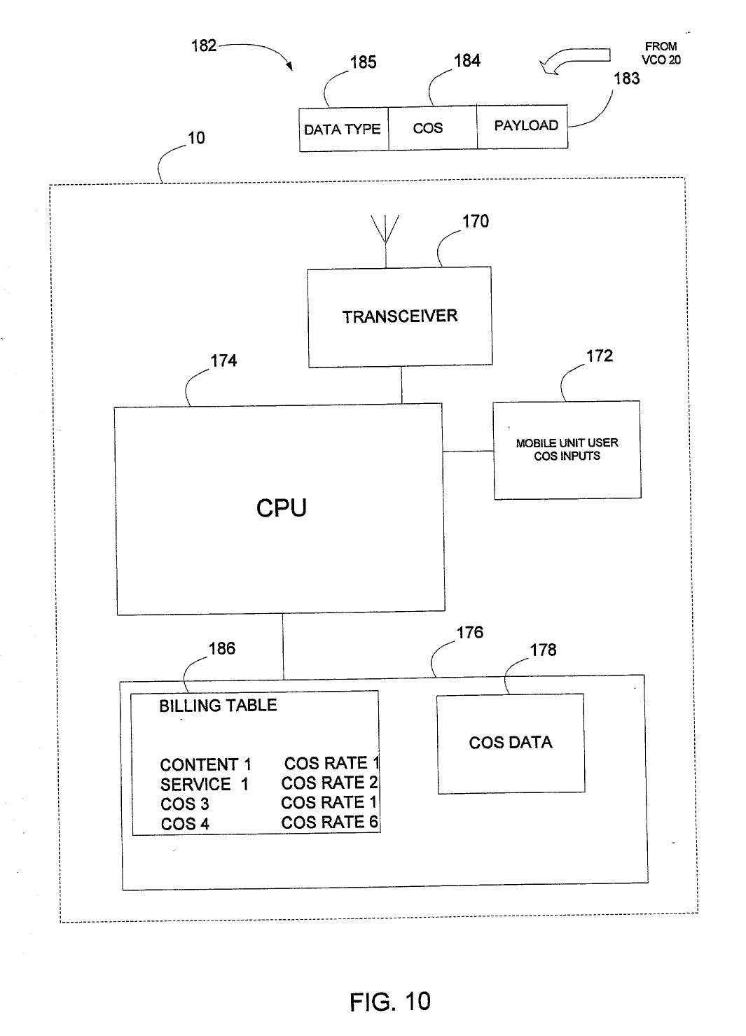

The COS data is continuously generated and encrypted in block 70 during the session. In block 72 the encrypted COS data is stored in nonvolatile memory, such as flash memory, in the mobile unit 10 (see FIG. 10). When the session is completed in decision block 74, the COS termination session is conducted with the VCO 20 in block 76.

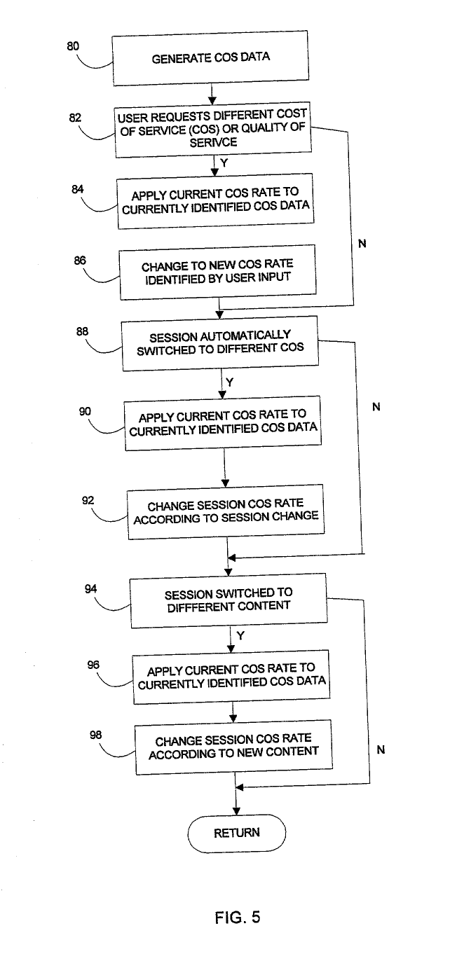

FIG. 5 shows in further detail an example of the different COS parameters that may be detected during the session by the mobile unit 10. In block 80 COS data is currently being generated by the mobile unit 10 according to current COS parameters for the session. In block 82 the mobile unit user requests a different service or Quality of Service for the session. For example, the user may request additional bandwidth or a higher priority for conducting a voice call or transmitting data. The mobile unit in block 84 uses the current COS rate for any previously transmitted and unaccounted for session data. The new COS rate is then determined in block 86 by the mobile unit 10. The new COS rate is then used for the subsequent session content.

Block 88 describes another example where the COS rate is automatically switched during the session either by the VOC 20 or the session itself. For example, the cost of transmitting content may change when the mobile unit moves into a different geographic location. In another example, the type of data that is transmitted during a portion of the session may have a different rate than the remainder of the session. The VCO 20 sends the new COS rate to the mobile unit in block 88. The current COS rate is applied to any remaining unaccounted content in block 90 and the new COS rate is applied to any new content in block 92.

Block 94 detects any change in the COS rate that may be caused purely by a change in the content transmitted during the session. The mobile unit 10 identifies the new content in block 94. The current COS rate is applied to the unaccounted content in block 96. A new COS rate is then identified by the mobile unit 10 and the new COS rate applied to the new content in block 98. The mobile unit 10 in one embodiment has a rate table that identifies COS rates for different types of content.

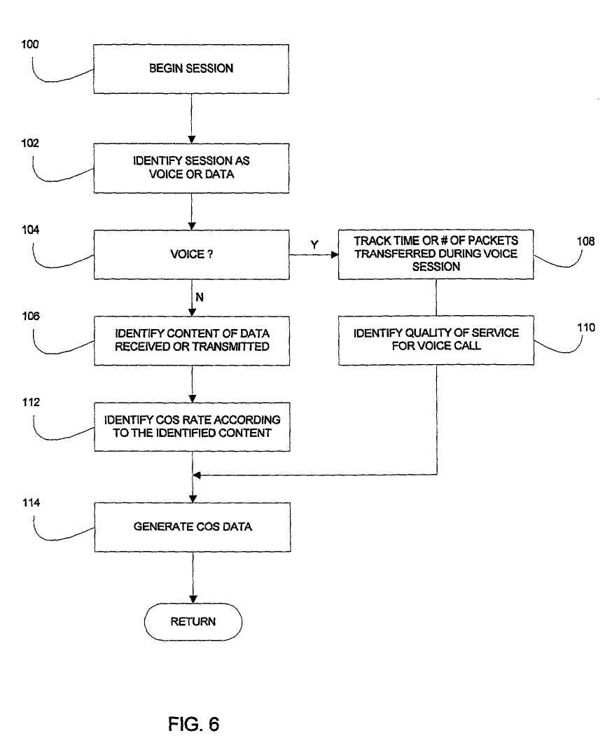

FIG. 6 shows in more detail how the COS rate is varied according to content. The session begins in block 100. In this example, the mobile unit 10 checks to see if the session is a voice session or a data session in block 102. If the session starts out as a voice call in decision block 104, the session may track the amount of time or number of packets transferred during the voice call in block 108. The Quality of Service of the voice call is then monitored in block 110.

If the session starts out transferring digital data, the content of the data transmitted or received is may be identified in block 106. For example, one type of digital data may be billed on a flat fee while another type of digital data may be billed according to the session connection time. The mobile unit identifies the COS rate for the identified digital data content in block 112. The COS data for the session is then generated according to the COS parameters identified in blocks 102-112.

The session may begin as a voice call at a particular QOS level. However, during the middle of the voice call, the mobile unit operator may request Global Positioning Service (GPS) content. The cost of the GPS data may not be determined according to the number of transmitted packets or the duration of the GPS data transmission. Conversely, the GPS data may be charged at a flat rate.

The mobile unit 10 detects the change in content request from voice to digital data in decision block 104. The mobile unit 10 then identifies the particular billing scheme used for the digital data in block 112. The GPS content itself, a configuration packet, of a table in the mobile unit 10 identifies the COS rate associated with the GPS content. The mobile unit 10 then uses the new COS rate for the GPS data. After the GPS data has been received, the mobile unit 10 reverts back or continues to monitor the voice call according to the parameters identified in blocks 108 and 110.

FIG. 7 shows in more detail the COS termination routine used after the session has completed. The COS termination routine is necessary to ensure that the COS data securely and reliably gets sent back to the network 24 (FIG. 1). In block 120 the mobile unit adds a content type identifier to the COS data stored in nonvolatile memory. The data type identifier 14 (FIG. 1) can be any label, address, packet, etc. sent to the VCO 20 to accurately route the COS data to the correct destination.

The COS data in mobile unit memory may be encrypted in block 122 for secure transmission to the VCO 20. For example, the VCO 20 supplies a public key to the mobile unit 10 during session initiation for encrypting the COS data. The mobile unit 10 encrypts the COS data according to the public key and then transmits the encrypted COS data to the VCO 20 in block 124. This same encryption also be performed during the session with the COS data stored in mobile unit memory as described above in FIG. 4.

The mobile unit 10 sends the VCO 20 the encrypted COS data in block 124 and then receives back and acknowledgement indicating the COS data has been successfully received. When the acknowledgement is received in block 126, the mobile unit in block 128 marks the COS data for the session as successfully transmitted in block 128 and ends the COS termination session in block 130. The mobile unit 10 now no longer has to worry about sending this COS data to the VCO 20. Accordingly, the COS data may be deleted by the mobile unit 10.

The transmission of the COS data to the VCO 20 may not be successful in block 126. This could happen if the mobile unit 10 moves outside the range of any VCO 20 or possibly goes underneath some obstruction that disrupts the wireless communication channel. Alternatively, the VCO 20 may currently be out of service or have no bandwidth available for receiving the COS data. While still connected to the VCO 20 during the present wireless or landline session, the mobile unit 10 first checks a timer or counter in block 132 that indicates how long or how many times the mobile unit 10 has tried to send the COS data to the VCO 20.

If the time out has not reached a predetermined threshold, then the mobile unit 10 attempts again to send the COS data to the VCO 20 in block 124. This is repeated until the COS data is successfully transmitted and received or until the time out threshold is reached in block 132. If the time out threshold is reached in block 132, the mobile unit 10 marks the COS data as unsuccessfully transmitted in block 134 and then ends the session in block 130. The next time a session is established with the VOC 20, the mobile unit 10 processes any COS data marked as unsuccessfully transmitted before continuing with the current session. This was previously described in FIG. 3.

In an alternative embodiment, the COS data can be output periodically by the mobile unit say on a monthly basis. The VOC 20 or the mobile unit 10 can initiate a COS accounting session where any un-transmitted COS data is transferred to the VCO 20 for forwarding to the correct service provider in network 24.

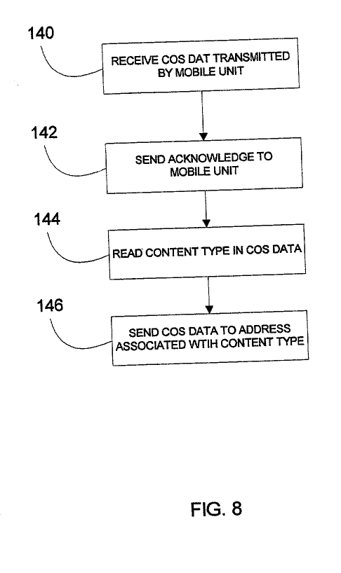

FIG. 8 shows in further detail how any one of the VCOs 20 processes the COS data after it is sent from the mobile unit 10. In block 140 the VCO 20 receives the COS data transmitted by the mobile unit 10. The VCO 20 sends an acknowledge in block 142 back to the mobile unit 10 indicating that the COS data has been received successfully. The VCO 20 may also decrypt the COS data before sending the acknowledgement to make sure the mobile unit 10 used the correct public key for encrypting the COS data.

The VCO 20 in block 144 reads the content type added to the COS data. The content type tells the VCO 20 how to transfer the COS data over the network 24. For example, the content type may indicate that the COS data for the session includes both email data, voice data, and GPS data. The VCO 20 may then reference a table that indicates addresses for routing each of the different content types to a different service address. In another example, the content type simply includes an IP address for forwarding different portions of the COS data.

If there are multiple services that each require accounting information for different portions of the same COS data, the VCO 20 identifies all of the IP addresses for each services from the content type information and then separately sends the COS data to the associated service address in block 146. In an alternative embodiment, the VCO 20 identifies only one service provider from the content type. The VCO 20 forwards the COS content to that service provider. That service provider is then required to forward the COS data to any other service providers that may participated in that session.

Each service provider may own the same or a unique private key associated with their portion of the COS data. The service provider uses their private keys to decrypt their portion of the COS data. In one implementation, the acknowledge back to the mobile unit may be sent individually by the service providers after successfully receiving and decrypting the encrypted COS data.

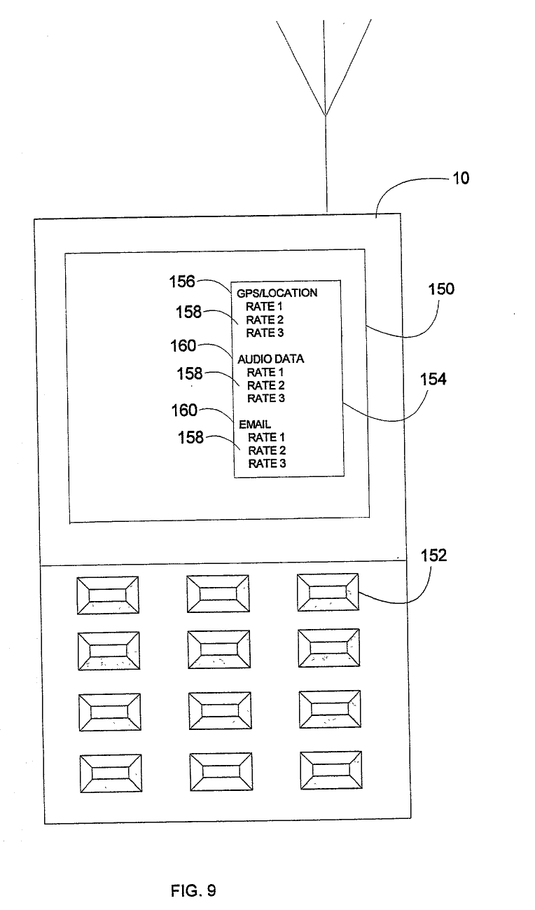

FIG. 9 is a detailed diagram of one of the mobile units 10 that conducts the session with the VCOs 20. In one embodiment, the mobile unit 10 is a cellular telephone. A screen 150 on the mobile unit 10 has one or more menus for 154 for selecting different services and/or rates associated with one or more sessions. For example, the mobile unit operator may initiate an email service 162 from the menu 154 by pressing buttons 152. This initiates a cellular call through a cellular communication network to anyone of the VCOs 20 in the network 24 (FIG. 1).

After establishing the session, the mobile unit 10 either transmits or receives packets provided with the selected email service. The mobile unit 10 tracks the number of packets or time of the email service. During the same session, the user may either change the rate 158 of the email service or change to a completely different service. For example, the user may request a GPS location transmission 156 from menu 154. During the same session, data is sent to the VCO 20 from the mobile unit 10 requesting GPS data.

The mobile unit 10 identifies the COS rate associated with the GPS service. Identifying the GPS COS rate may be triggered when the user selects the GPS request from the menu 154 in mobile unit 10. Alternatively, the GPS COS rate may be identified by the GPS packets received by the mobile unit 10. The transmitted GPS packets would include a COS value in the packet header that is read by the mobile unit 10 to determine the GPS COS rate.

In one example, the GPS data may be billed on a flat rate while the email service may be billed on a per/packet basis. The mobile unit 10 then counts email packets to determine the COS data for the email service and stores a single flat fee for the GSP service. Either automatically or via a user selection on menu 154, the mobile unit 10 may move from the GPS service 154 back to the email service 158.

During the same session the user may desire to receive and transmit the email messages with higher priority. The user selects rate 1 in the rates 158 below the email service 162. The mobile unit 10 sends whatever control packets are necessary to the VCO 20 to move into the higher priority packet transmission level. The mobile unit 10 also automatically changes the COS rate used for the email service to reflect the higher priory.

FIG. 10 is a detailed diagram of the mobile unit 10. The mobile unit 10 includes a transceiver 170 for transmitting and receiving data over a wireless communication channel. A Central Processing Unit (CPU) 174 processes the data received over the communication channel from the VCO 20. Inputs from the user that effect the COS rate are received at input 172. In the example, shown in FIG. 9, the inputs were from a keypad and menu screen.

The mobile unit 10 includes a memory 176, such as flash memory, that stores both the COS data 178 and a billing table 180 that provides different COS rates according to different service identifiers such as a content identifier, type of service identifier, time of day identifier, or a generic COS label that is referenced in the billing table 180. The identifiers in billing table 180 operate essentially as pointers to particular billing rates in the billing table 180.

The CPU 174 receives the billing table pointers either in packets 182 transmitted by the VCO 20 or from the mobile user inputs 172. For example, the packets 182 may include a payload 183, a COS label 184, and a data type 185. The CPU 174 reads the COS label 184 or the data type 185 as a pointer in memory 176 to determine the COS rate in billing table 180. The CPU 174 uses the identified COS rate until another COS label 184 or data type 185 is received in one of the packets 182 or from the mobile unit inputs 172.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the invention in a preferred embodiment thereof, it should be apparent that the invention may be modified in arrangement and detail without departing from such principles. Claim is made to all modifications and variation coming within the spirit and scope of the following claims.

1. A method for monitoring packet based communications in a mobile environment, comprising:
establishing a session;
transferring content during the session;
identifying a cost of service rate for the content;
generating cost of service data according to the content and the identified Cost of Service rate; and
sending the cost of service data to a service provider.

2. A method according to claim 1 including receiving the content at a mobile unit and generating the cost of service data in the mobile unit.

3. A method according to claim 1 including conducting a cost of service protocol with a network at a session layer or higher in a IOS model used by the network, the cost of service protocol providing parameters for identifying the cost of service rate and generating the cost of service data.

4. A method according to claim 1 including identifying an amount of content by tracking a number of packets transferred during the session or a duration of the session and using the identified amount of content to generate the cost of service data.

5. A method according to claim 1 including identifying a type of content transferred during the session and using the identified type of content to generate the cost of service data.

6. A method according to claim 5 including:
dynamically identifying different types of content that are transferred during the session;
dynamically identifying different cost of service rates associated with each of the identified different types of content; and
applying the different cost of service rates to the associated identified different types of content to generate the cost of service data.

7. A method according to claim 6 including:
identifying a first type of content associated with a voice portion of the session and using a first cost of service rate for tracking a voice cost of service for the voice portion;
identifying a second type of content associated with a digital data potion of the session and using a second cost service rate for tracking a data cost of service for the digital data portion; and
combining the voice cost of service with the data cost of service to generate the cost of service data.

8. A method according to claim 1 including identifying different cost of service rates requested from the network or from a local mobile unit operator and generating the cost of service data according to the identified cost of service rates.

9. A method according to claim 1 including:
detecting an end of the session;
transmitting the cost of service data to a network;
terminating the session when an acknowledge is received from the network indicating that the cost of service data has been successfully received; and
flagging cost of service data as unsuccessfully transmitted when the acknowledge is not received from the network.

10. A method according to claim 9 including:
periodically retransmitting the cost of service data when no acknowledge is received from the network;
repeating the retransmission until the acknowledge has been received or a timeout period has occurred;
flagging the cost of service data as being unsuccessfully transmitted when no acknowledge is received before the timeout period; and
terminating the session.

11. A method according to claim 10 including:
establishing another session with the network;
checking for any cost of service data in the mobile unit flagged as unsuccessfully transmitted;
retransmitting the flagged cost of service data to the network; and
waiting for an acknowledge from the network that the flagged cost of service data has been successfully received before continuing the other session.

12. A method according to claim 1 including:
receiving a public key from the network during the establishment of the session;
encrypting the cost of service data generated in a mobile unit according to the public key; and
sending only the encrypted cost of service data to the network.

13. A method according to claim 1 including identifying the cost of service rate according to both an identified quality of service and an identified content associated with the session.

14. A mobile communication unit, comprising:
a processor configured to establish a wireless session and transfer content during the session, the processor further configured to identify a cost of service rate for the content and generate cost of service data according to the content and the identified cost of service rate.

15. A mobile communication device according to claim 14 including a memory configured to store the cost of service data during the session.

16. A mobile communication unit according to claim 15 wherein the memory includes a billing table for identifying different cost of service rates associated with different types of content and different types of services identified by the processor during the session.

17. A mobile communication device according to claim 15 wherein the processor is configured to encrypt the cost of service data stored in the memory.

18. A mobile communication device according to claim 14 including a user input configured to manually modify the content or the cost of service rate for the session.

19. A mobile communication device according to claim 18 wherein the processor dynamically changes the cost of service rate used for generating the cost of service data associated with the content according to the user input.

20. A mobile communication device according to claim 18 wherein the user input comprises a menu and key entries in a cellular telephone.

21. A mobile communication device according to claim 14 wherein the processor is configured to conduct a cost of service protocol at a session layer or higher with a network that establishes the parameters used for generating the cost of service data.

22. A mobile communication device according to claim 14 wherein the processor is configured to identify an amount of content by tracking a number of content packets or a duration of the session and use the identified amount of content to generate the cost of service data.
